(19) United States
(12) Patent Application Publication
(10) Pub. No.: US 2007/0032333 A1
(43) Pub. Date: Feb. 8, 2007

(54) Integrated transaxle power take off

(76) Inventor: William R. Kelley JR., Novi, MI (US)

Correspondence Address: BORGWARNER INC., PATENT DEPARTMENT, 3850 HAMLIN ROAD, AUBURN HILLS, MI, 48326-2872, US

(21) Appl. No.: 11/197,938

(22) Filed: Aug. 5, 2005

(51) Int. Cl. F16H 48/06

(52) U.S. Cl. 475/220

(57) ABSTRACT

A four wheel drive vehicle driveline includes a primary driveline having a prime mover on the transaxle and half shafts at the front of the vehicle and a secondary driveline including a prop shaft, friction clutch assembly, differential and half shafts at the rear of the vehicle. A bevel gear set and an offset chain drive assembly couple the transaxle output to the rear prop shaft.

### TECHNICAL FIELD

The invention relates generally to four wheel drive motor vehicle drivelines and more particularly to a motor vehicle driveline having a front transaxle driving a front or primary driveline and a rear or secondary driveline through a bevel gear and offset chain drive assembly.

### BACKGROUND OF THE INVENTION

The popularity of and the desire to own four wheel drive vehicles continues to direct consumer purchases. Virtually all vehicles from passenger cars through sport utility vehicles, crossover vehicles, light trucks, pick-up trucks and heavy duty trucks offer a four wheel drive configuration. The majority of these vehicles have a primary driveline disposed at the rear of the vehicle. The primary driveline operates full time. A secondary driveline disposed at the front of the vehicle is driven as operating conditions require by a clutch in a transfer case. This clutch will typically be modulatable and will provide torque to the secondary driveline in response to sensed operating conditions and instructions contained in software residing in an onboard processor. The transfer case may also contain a speed reduction assembly to provide a lower speed, higher torque operating range for the vehicle.

There are also four wheel drive configurations wherein the primary driveline is disposed at the front of the vehicle and a secondary, typically part-time, driveline is disposed at the rear of the vehicle. In such systems, the primary driveline is typically coupled to an output of a transaxle which also drives the secondary driveline.

Providing drive torque to the secondary driveline in a front wheel drive vehicle can be problematic inasmuch as the typical transaxle output is offset from the longitudinal centerline of the vehicle whereas the secondary prop shaft is generally accommodated and disposed along the longitudinal centerline of the vehicle. The present invention addresses this situation and provides a compact and relatively lightweight assembly that provides drive torque to the rear wheels of a vehicle having a transaxle along the longitudinal centerline of the vehicle.

### SUMMARY

A four wheel drive vehicle driveline includes a primary driveline having a prime mover, a transaxle and half shafts at the front of the vehicle and a secondary driveline including a prop shaft, friction clutch assembly, differential and half shafts at the rear of the vehicle. One gear of a bevel gear set is attached to the cage of the differential in the transaxle and the other bevel gear drives an offset chain drive assembly which couples the transaxle output to the rear prop shaft.

Thus it is an object of the present invention to provide a drive assembly for a secondary driveline in a four wheel drive vehicle having front wheel drive and a transaxle.

It is a further object of the present invention to provide a front wheel drive vehicle having a transaxle and a chain drive to a secondary prop shaft.

It is a still further object of the present invention to provide a front wheel drive motor vehicle having a transaxle and offset output to a secondary prop shaft on the longitudinal centerline of the vehicle.

Further objects and advantages of the present invention will become apparent by reference to the following description of the preferred embodiment and appended drawings wherein like reference numbers refer to the same component, element or feature.

### BRIEF DESCRIPTION OF THE DRAWINGS

FIG. 1 is a diagrammatic view of a four wheel drive motor vehicle incorporating the present invention;

FIG. 2 is an enlarged, fragmentary view of the transaxle output and chain drive to a secondary prop shaft in a motor vehicle incorporating the present invention; and

FIG. 3 is an enlarged, full sectional view of an electromagnetic friction clutch disposed in the secondary driveline of a motor vehicle incorporating the present invention.

### DESCRIPTION OF THE PREFERRED AND ALTERNATE EMBODIMENTS

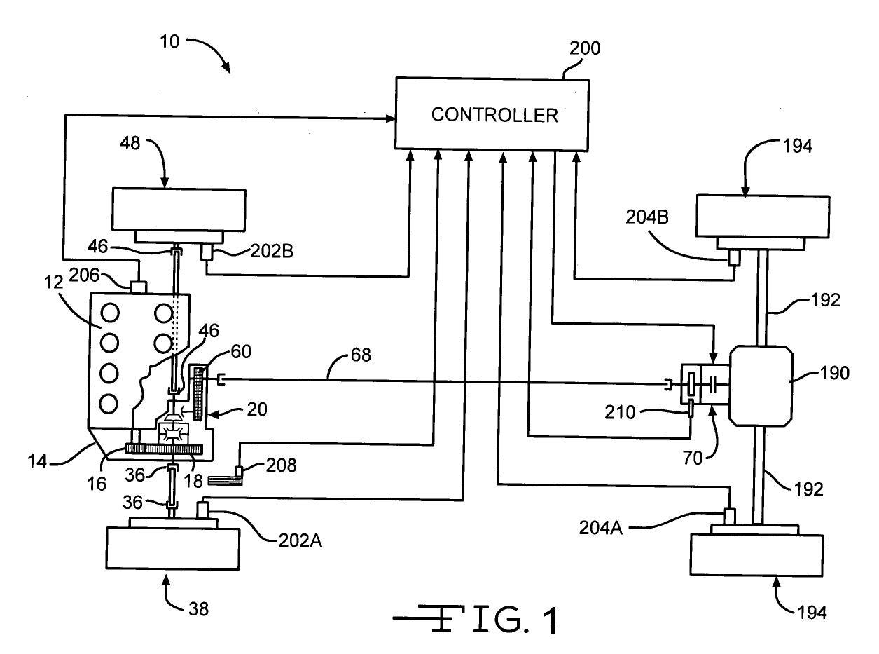

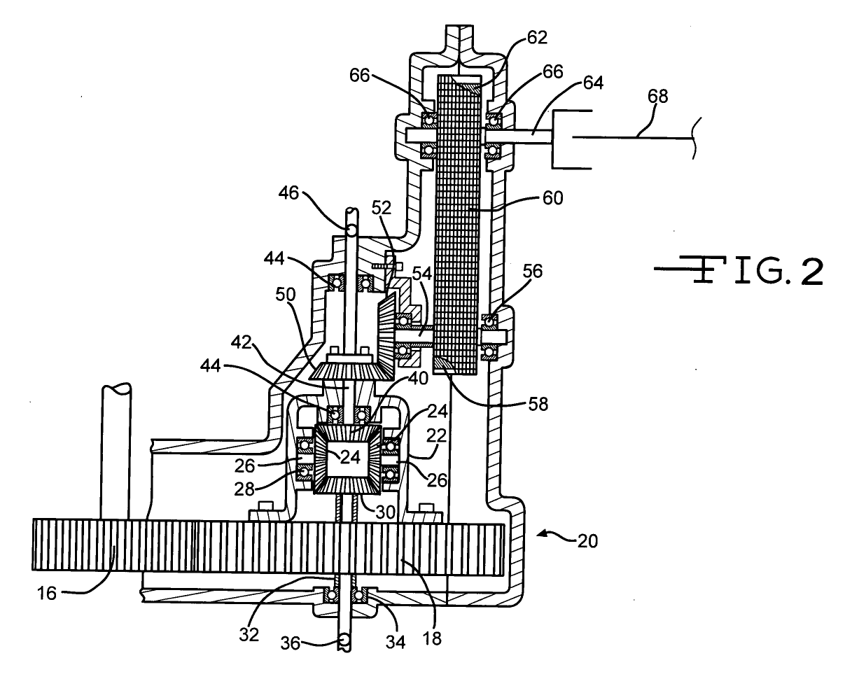

Referring now to FIGS. 1 and 2, a four wheel drive motor vehicle incorporating the present invention is illustrated and generally designated by the reference number 10. The four wheel drive motor vehicle 10 may be a passenger car, sport utility vehicle, cross-over vehicle, pick-up truck or truck having a prime mover 12 such as an internal combustion gas or Diesel engine or hybrid power plant located at the front of the vehicle 10. The prime mover 12 directly drives a transaxle 14, i.e., a transmission and front axle combination. The transaxle 14 includes a transmission output gear 16 which engages a differential input gear 18. The ratio between the transmission output gear 16 and the differential input gear 18 is the final drive ratio and may be, for example, 3.765 to 1, 4.06 to 1, 4.40 to 1, 4.64 to 1 or some other desired ratio. The differential input gear 18 is a component of a differential assembly 20 having a differential cage 22. The differential cage 22 is secured to and rotates with the differential input gear 18. A pair of idler bevel gears 24 are freely rotatably supported within the differential cage 22 on a respective pair of stub shafts 26 and anti-friction bearing assemblies such as ball bearing assemblies 28. Alternatively, both of the idler bevel gears 24 may be supported upon a single cross shaft (not illustrated) which extends between the ball bearing assemblies 28. A first or left bevel output gear 30 engages both of the idler bevel gears 24 and is secured to and rotates a left output shaft 32 which is supported on suitable anti-friction bearings such as ball bearing assemblies 34. The left output shaft 32 is coupled through suitable constant velocity universal joints 36 to a left tire and wheel assembly 38. Similarly, a second or right bevel output gear 40 is engaged by both of the idler bevel gears 24 and is supported upon a right output shaft 42 which in turn is rotatably supported by a pair of anti-friction assemblies such as ball bearing assemblies 44. The right output shaft 42 includes constant velocity universal joints 46 and drives the right front tire and wheel assembly 48.

Secured to the differential cage 22 is a third or rear output bevel gear 50 which meshes with and drives a fourth or rear output bevel gear 52 disposed upon a stub shaft 54. The stub shaft 54 is supported on suitable anti-friction bearings such as ball bearing assemblies 56 and drives a chain drive sprocket 58. The chain drive sprocket 58 engages a wide, multi-link chain 60 which, in turn, engages a driven chain sprocket 62 transversely offset from the chain drive sprocket 58 and disposed upon a rear output shaft 64. The rear output shaft 64 preferably rotates on an axis coincident with a longitudinal centerline of the vehicle 10. The axis at the fourth output bevel gear 52 and the chain drive sprocket 58 is transversely offset from a longitudinal centerline of the vehicle 10. The rear output shaft 64 is supported upon anti-friction bearings such as ball bearing assemblies 66 and drives a secondary or rear prop shaft 68. Suitable universal joints may be associated with the rear prop shaft 68 to accommodate static and dynamic offsets to which it may be subjected. The rear prop shaft 68 rotates on an axis preferably coincident with a longitudinal centerline of the vehicle 10. The rear prop shaft 68, in turn, drives an electromagnetic clutch assembly 70.

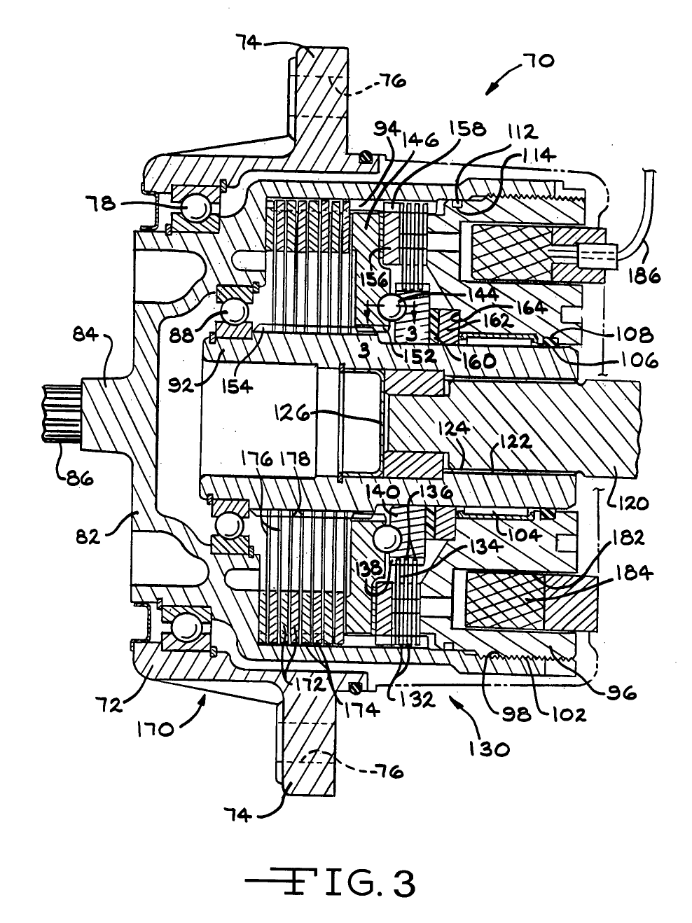

Referring now to FIG. 3, the electromagnetic clutch assembly 70 includes a cylindrical housing 72 having a flange or a plurality of ears 74 defining a plurality of through openings 76 which are adapted to receive threaded fasteners (not illustrated) which secure the clutch assembly 70 to associated components. The cylindrical housing 72 receives and supports a ball bearing assembly 78 which rotatably supports a bell-shaped input member 82. The input member 82 may include a stub shaft 84 having male splines 86 or other positive drive feature. A second ball bearing assembly 88 rotatably supports a cylindrical output hub 92. The interior cylindrical wall of the input member 82 defines a plurality of female splines or gear teeth 94.

Disposed radially intermediate the cylindrical input member 82 and the cylindrical output hub 92 is a clutch annulus 96 having male threads 98 about its periphery which are complementary to and engage female threads 102 on the inner surface of the input member 82. Between the clutch annulus 96 and the output hub 92 is a roller bearing assembly 104. A fluid tight elastomeric seal 106 is received within a circumferential groove 108 on the inside surface of the clutch annulus 96 adjacent the roller bearing assembly 104 and provides a fluid tight seal between the output hub 92 and the clutch annulus 96. A seal is also provided between the outer surface of the clutch annulus 96 and the input member 82 by an O-ring 112 which is received within a circumferential groove 114 in the clutch annulus 96. An output shaft 120 preferably includes male splines 122 which engage female splines 124 on the cylindrical output hub 92. A suitable oil seal 126 is disposed within the output hub 92 and maintains a fluid tight interior region generally within the cylindrical input member 82.

The electromagnetic clutch assembly 70 includes a primary or pilot clutch pack 130 having a first plurality of larger diameter clutch plates 132 with male or exterior splines which engage the female splines 94 within the input member 82. Thus, the larger diameter friction clutch plates 132 rotate with the input member 82. Interleaved with the first plurality of larger diameter clutch plates 132 is a second plurality of smaller diameter clutch plates 134 which have internal or female splines 136 which engage complementarily configured male splines 138 on a first circular member or plate 140 which is freely rotatably received upon the cylindrical output hub 92. The first and second plurality of clutch plates 132 and 134 include suitable friction material disposed on at least one surface of each plate. The first circular plate 140 includes a plurality of ramp-like recesses 142 arranged in a circular pattern about the axis of the output hub 92. The recesses 142 define an oblique section of a helical torus. Disposed within each of the recesses 142 is a load transferring roller or ball 144 which rolls along the ramps defined by the oblique surfaces of the recesses 142. A second circular member or plate 146 of larger diameter is disposed in opposed relationship with the first circular plate 140 and includes a like plurality of complementarily sized and arranged recesses 148. The load transferring balls 144 are thus received and trapped within the pairs of opposing recesses 142 and 148, the ends of the recesses 142 and 148 being curved and much steeper in slope than the interior regions of the recesses 142 and 148 such that the load transferring balls 144 are effectively trapped in the regions defined thereby.

The second circular plate 146 includes a plurality of female splines or gear teeth 152 which are complementary to and engage male splines or gear teeth 154 on the output hub 92. A circular plate 156 having splines 158 which engage the female splines 94 on input member 82 is disposed between the first or pilot clutch pack 130 and the second circular member 146.

On the face of the first circular plate 140 opposite the second circular plate 146 is an annular flat washer 160. On the face of the flat washer 160 opposite the first circular plate 140 is a backup or support annular member 162 which seats within a circumferential triangular groove 164 in the clutch collar 96. The flat washer 160 is preferably made of plastic such as a thermoplastic polyimide or similar material.

A secondary or main friction pack assembly 170 resides between the second circular member 146 and a radially and circumferentially extending surface of the input member 82. The main friction clutch pack assembly 170 includes a first plurality 172 of larger diameter clutch plates having male splines 174 which drivingly engage the splines 94 on the input member 82. Interleaved with the first plurality of larger diameter friction plates 172 is a second plurality of smaller diameter plates 176 having female splines 178 which engage the complementarily configured male splines 154 on the cylindrical output hub 92. Once again, the first and second plurality of clutch plates 172 and 174 include suitable friction material disposed on at least one surface of each plate. Disposed within a suitable recess 182 of the clutch annulus 96 is an electromagnetic coil 184. The electromagnetic coil 184 is energized by electricity provided to it by at least one electrical line 186.

The output shaft 120 of the electromagnetic clutch assembly 70 directly drives a conventional rear differential assembly 190 illustrated in FIG. 1. The rear differential 190 differentially drives a pair of rear axles 192 which, in turn, are connected to and drive a pair of rear tire and wheel assemblies 194.

Typically, the action of the electromagnetic clutch assembly 70 will be controlled by a microprocessor or controller 200 which receives signals and data from various sensors on the motor vehicle 10, conditions such signals, processes them in accordance with various software, look-up tables and sub-routines and provides an output such as a pulse width modulated (PWM) signal to the electromagnetic clutch assembly 70 in the electrical line 186 to selectively provide torque to the rear differential assembly 190. Such sensors include front tire and wheel speed sensors 202A and 202B and rear tire and wheel speed sensor assemblies 204A and 204B. Such sensors 202A, 202B, 204A and 204B are preferably Hall effect sensors and may be dedicated for this purpose only, or more commonly, may be part of a vehicle ABS or traction control system. In the latter case, the wheel speed signals may be utilized from or derived from the car area network (CAN) or a similar data bus or system. A motor speed sensor 206 provides data regarding the speed of the prime mover 12 to the controller 200 and a throttle position sensor 208 provides a signal to the controller 200 regarding current position of the throttle. A rear prop shaft speed sensor 210 which may be disposed at the input of the electromagnetic clutch assembly 70 provides data regarding the current speed of the prop shaft 68 which drives the electromagnetic clutch assembly 70. The microprocessor or controller 200 includes signal conditioning, memory, software and subroutines, lookup tables and the like to process the signals from the sensors and provide an output which drives, i.e., engages, the electromagnetic clutch assembly 70 and provides torque to the rear tire and wheel assemblies 194.

It will be appreciated that a transaxle power take off, i.e., a drive assembly for providing drive torque to the rear wheels of a front wheel drive vehicle having a transaxle according to the present invention is a compact and relatively lightweight assembly that may be adapted to and utilized with a conventional prime mover/transaxle package with minimum revision and re-engineering of the package. This is especially significant if the vehicle manufacturer wishes to offer a front wheel drive vehicle both with and without supplemental rear wheel drive.

The foregoing disclosure is the best mode devised by the inventor for practicing this invention. It is apparent, however, that apparatus incorporating modifications and variations will be obvious to one skilled in the art of motor vehicle transaxle and drive assemblies. Inasmuch as the foregoing disclosure presents the best mode contemplated by the inventor for carrying out the invention and is intended to enable any person skilled in the pertinent art to practice this invention, it should not be construed to be limited thereby but should be construed to include such aforementioned obvious variations and be limited only by the spirit and scope of the following claims.

I/We claim:

1. An integrated transaxle drive for a front wheel drive motor vehicle comprising, in combination,
a differential assembly adapted to be driven by a transmission output member and including a cage, a pair of opposed idler bevel gears, a first output bevel gear engaging said idler bevel gears and coupled to a first output shaft, a second output bevel gear engaging said idler bevel gears and coupled to a second output shaft and a third output bevel gear secured for rotation with said differential cage,
a driven bevel gear engaging said output bevel gear,
a chain drive sprocket coupled to said driven bevel gear,
a driven chain sprocket offset from said chain drive sprocket,
a drive chain engaging said drive and driven chain sprockets, and
an output shaft coupled to said driven chain sprocket.

2. The integrated transaxle drive for a front wheel drive motor vehicle of claim 1 wherein said driven bevel gear rotates on an axis parallel to and offset from the longitudinal centerline of said vehicle.

3. The integrated transaxle drive for a front wheel drive motor vehicle of claim 1 further including a transmission having an output member.

4. The integrated transaxle drive for a front wheel drive motor vehicle of claim 1 wherein said pair of opposed idler bevel gears are disposed on respective stub shafts.

5. The integrated transaxle drive for a front wheel drive motor vehicle of claim 1 further including a friction clutch assembly driven by said output shaft.

6. The integrated transaxle drive for a front wheel drive motor vehicle of claim 1 further including an electromagnetic friction clutch assembly having a pilot clutch and a main clutch.

7. The integrated transaxle drive for a front wheel drive motor vehicle of claim 1 wherein said drive between said transmission output member and said differential assembly effects a speed reduction.

8. An auxiliary drive assembly for a front wheel drive motor vehicle comprising, in combination,
a differential having an input member, a cage coupled to said input member, a pair of opposed idler bevel gears disposed within said cage, a first output bevel gear engaging said idler gears, a second output bevel gear opposed to said first bevel gear and engaging said idler gears and a third output bevel gear secured for rotation with said differential cage,
a driven bevel gear engaging said third output bevel gear,
a chain drive sprocket driven by said third output bevel gear,
a driven chain sprocket offset from said chain drive sprocket, and
a drive chain disposed about and engaging said chain drive and said driven chain sprockets.

9. The auxiliary drive assembly for a front wheel drive motor vehicle of claim 8 further including an output shaft coupled to said driven chain sprocket.

10. The auxiliary drive assembly for a front wheel drive motor vehicle of claim 9 further including a friction clutch assembly driven by said output shaft.

11. The auxiliary drive assembly for a front wheel drive motor vehicle of claim 8 further including a transmission having an output driving said input member.

12. The auxiliary drive assembly for a front wheel drive motor vehicle of claim 8 wherein said input member is a spur gear.

13. The auxiliary drive assembly for a front wheel drive motor vehicle of claim 8 wherein said driven bevel gear rotates on an axis parallel to and offset from the longitudinal centerline of said vehicle.

14. The auxiliary drive assembly for a front wheel drive motor vehicle of claim 8 wherein said pair of opposed idler bevel gears are disposed on respective stub shafts.

15. An integrated power take-off for a front wheel drive vehicle having a transaxle comprising, in combination,
a differential assembly having an input gear, a rotatable cage coupled to said input gear, a pair of rotatable opposed idler bevel gears disposed within said differential cage, a first output bevel gear disposed within said cage and engaging said idler bevel gears, a first output shaft coupled to said first output gear, a second output bevel gear disposed within said cage and engaging said idler bevel gears, a second output shaft coupled to said second bevel gear and a third output bevel gear secured to said differential cage for rotation therewith,
a driven bevel gear engaging said third output bevel gear,
a drive sprocket coupled to said driven bevel gear,
a driven chain sprocket offset from said chain drive sprocket and,
a drive chain engaging said chain drive sprocket and said driven chain sprocket.

16. The integrated power take-off for a front wheel drive vehicle of claim 15 further including an output shaft coupled to said driven chain sprocket.

17. The integrated power take-off for a front wheel drive vehicle of claim 16 further including a friction clutch assembly driven by said output shaft.

18. The integrated power take-off for a front wheel drive vehicle of claim 15 wherein said pair of opposed idler bevel gears are disposed on respective stub shafts.

19. The integrated power take-off for a front wheel drive vehicle of claim 15 further including a transmission having an output driving said input gear.

20. The integrated power take-off for a front wheel drive vehicle of claim 19 wherein said drive between said transmission output and said input gear of said differential assembly effects a speed reduction.
